(19) United States
(12) Patent Application Publication
(10) Pub. No.: US 2017/0109822 A1
(43) Pub. Date: Apr. 20, 2017

(54) NETWORK COMMUNICATION SYSTEM FOR EXCHANGE TRADING

(71) Applicant: ITG SOFTWARE SOLUTIONS, INC, Culver, CA (US)

(72) Inventors: Milan BORKOVEC, New York, NY (US); Ian DOMOWITZ, New York, NY (US)

(73) Assignee: ITG SOFTWARE SOLUTIONS, INC, Culver, CA (US)

(21) Appl. No.: 15/127,864

(22) PCT Filed: Mar. 20, 2015
(86) PCT No.: PCT/US15/21836

§ 371 Date: Sep. 21, 2016

Related U.S. Application Data
(60) Provisional application No. 61/968,804, filed on Mar. 21, 2014.

(51) Int. Cl. G06Q 40/04

(52) U.S. Cl. CPC G06Q 40/04

(57) ABSTRACT

A network communication system and method are provided. The system and method communicate in a electronic trading environment and receive and send signals representing trading information in order to determine trading cost for trading pairs of currencies. In an embodiment, the system may request electronic price quotes from the set of electronic trading venues and may receive the electronic price quotes over a network. The system and method generates a cost curves that relates trading cost to order size for a plurality of order sizes. The system and method may determine trading costs for an electronic trade order based on the cost curves.

### CROSS REFERENCE TO RELATED APPLICATION(S)

This application claims priority to U.S. Application No. 61/968,804, filed Mar. 21, 2014. The entirety of the disclosure of the above-referenced application is incorporated herein by reference.

### BACKGROUND OF THE INVENTION

### Field of the Invention

This invention relates generally to network communication systems for exchange trading. More particularly, the invention relates to systems, methods, and computer program products for network communications with disparate sources, in an electronic market, and for estimating foreign exchange trading cost based on a cost estimation model and the network communications

### SUMMARY OF THE INVENTION

An object of the present invention is to provide network communication systems and methods for communicated to a plurality of disparate electronic data sources in an electronic marketplace. According to embodiments of the invention, the systems and methods may include estimating, based on communications received by a network communication interface, trading costs associated with trading a first currency for a second currency (i.e., with trading a currency pair made up of the first currency and the second currency). “Trading costs” refers to implicit trading costs (e.g., market impact) and not to explicit costs, such as taxes and commissions. Trading cost may include a measure of cost of liquidity. That is, as order size increases, purchase price of the first currency may rise (i.e., require more quantity of the second currency), and sale price of the first currency may decrease (i.e., trade for less quantity of the second currency). In some instances, this cost of liquidity may be reflected in difference between a purchase price for the first currency and a sale price for the first currency (i.e., a bid/ask spread). In a more specific example, in the case of an electronic Forex market providing electronic data describing an ask quote (i.e., an electronic ask quote) for a currency pair and electronic data describing a bid quote (i.e., an electronic bid quote) for the currency pair, the trading cost may be calculated as a half-spread of the ask quotes and bid quotes. The half-spread may be a difference between a mid-quote (i.e., a middle value of a bid quote and an ask quote) and one of the electronic ask quote or the electronic bid quote.

The discussion herein recognizes that using electronic data that describe indicative quotes (i.e., a quote, such as one from a market maker, that is non-binding) to estimate trading cost may not be optimal because indicative quotes tend to overestimate the cost for small trades and underestimate the cost for larger trades, and because they are not updated at a sufficient pace to reflect changes in market volatility. The discussion herein relates to estimating trading costs in a more optimal manner through an electronic pre-trade foreign exchange (FX) smart cost estimator that, in some embodiments, calculates at least two trading costs that are based on different assumptions of a trader's access to liquidity. The pre-trade FX smart cost estimator further is able to take changes in market volatility into account when calculating the trading costs.

According to embodiments of the present invention, a network communication system and method are provided to facilitate currency exchange by, based on network communications received by a network communication interface, calculating data representing an estimate of trading cost for trading pairs of currencies. More particularly, the system and method are provided for receiving electronic data describing price quotes (e.g., dealer quotes) from a set of electronic trading venues that provide access to currency trading (e.g., to trade a first currency for a second currency). In an embodiment, the system may receive the electronic data from servers operated by the set of electronic trading venues over a network.

In an embodiment, the network communication system and method generate electronic data representing a first cost curve that relates trading cost to order size for a plurality of order sizes. That is, the cost curve presents trading cost as a function of order size. As stated above, the electronic trading cost (i.e., cost of performing electronic trading) may be based on a difference between a purchase price for a first currency (e.g., how many Polish Zloty are needed to buy 1 US dollar) and a sale price for the first currency (e.g., how many Polish Zloty will another party pay for 1 US dollar). More specifically, the electronic trading cost may be based on a half-bid/ask spread for a currency pair. In the embodiment, the first cost curve is generated based on electronic data describing price quotes from the set of electronic trading venues.

In an embodiment, the network communication system and method generates a second cost curve that also relates electronic trading cost to order size for a plurality of order sizes. However, the second cost curve is generated based on electronic data describing price quotes corresponding to a subset of the set of electronic trading venues. The subset is smaller than the set of electronic trading venues. For instance, the set of electronic trading venues may include all banks and electronic communication networks (ECNs) that trade in a particular currency pair, while the subset may include only the ECNs that trade in the currency pair. The second cost curve may thus calculate electronic trading cost based on an assumption that a trader does not have access to all the sources of liquidity for trading a particular currency pair. Thus, the second cost curve may reflect a situation in which a trader faces higher trading costs because its sources of liquidity are more limited. The first cost curve, on the other hand, may reflect a situation in which a trader (e.g., a large bank or institutional investor) faces lower trading costs because it has greater access to liquidity for a particular currency pair.

In an embodiment, the first cost curve may be treated as a lower bound on an estimated trading cost, while the second cost curve may be treated as an upper bound on the estimated trading cost. Thus, the system and method may output electronic data identifying a first trading cost for an electronic trade order (e.g., an electronic order to trade a currency pair) based on the first cost curve and electronic data identifying a second cost for the electronic trade order based on the second cost curve. The electronic data identifying the first cost may represent a low estimate of the trading cost, while the electronic data identifying the second cost may represent a high estimate of the trading cost.

In an embodiment, the first trading cost and the second trading cost may be transmitted to a network communication interface, which may in turn transmit the first trading cost and the second trading cost to a client device.

According to embodiments of the present invention, the set of electronic trading venues includes all available trading venues that trade the first currency for the second currency.

According to embodiments of the present invention, the set of electronic trading venues includes all available banks that trade the first currency for the second currency and all available electronic communication networks (ECNs) (e.g., alternative trading systems (ATSs)) that trade the first currency for the second currency.

According to an embodiment of the present invention, the network communication system and method can further determine a volatility value that indicates a level of volatility in the currency market, such as volatility in a purchase price or sale price of the first currency. Then, at least one of the first cost curve and the second cost curve is adjusted based on the determined volatility value. More specifically, a cost curve may be associated with an initial level of volatility (e.g., a normal level of market volatility). In response to a change in the level of volatility, the cost curve may be adjusted upward (for an increasing level of volatility) or downward (for a decreasing level of volatility).

According to an embodiment of the present invention, the network communication system and method receives electronic data describing one or more currency option contracts. The volatility value may be determined based on the electronic data describing the one or more currency option contracts.

According to embodiments of the present invention, four different cost curves may be generated and made available to a user. Using the empirical order book provides the ability to construct cost estimates for instantaneous trading for various consolidation levels and for different order sizes and times of the day. A model can provide four cost estimates reflecting the cost of instantaneously sweeping the limit order book for four different regation schemes (ALL, CECN, AVG, MIN) depending on the end users' objectives and capabilities.

The first scheme (ALL) corresponds to consolidating liquidity across all available venues. Given the current fragmentation of data sources and the mixed nature of the dealer-ECN FX markets, the associated cost estimate provides a lower bound of the expected cost. It is based on the liquidity accessible to a hypothetical market participant who is patient and resourceful enough to search for the liquidity available on different venues (dealers and ECNs) nearly instantaneously, has credit standing and dealer relationships which are adequate to repeatedly access all liquidity from the participating dealer banks.

The second scheme (CECN) aggregates liquidity only across available ECNs. Sourcing liquidity from an ECN book is typical for a trader who wants to transact smaller quantities, and who is not willing or not able to interact with a dealer bank. However, it can be assumed that a trader is not limited to a single trading venue, and is able to instantaneously sweep the liquidity available in different ECNs.

The two remaining schemes do not involve limit order book consolidation across different trading venues. Both of these schemes rely on the liquidity available from a single bank dealer. The third scheme (AVG) computes the cost of climbing the limit order book of each dealer bank separately, and then calculates the average cost (across banks) for a given trade quantity. The cost computed in this manner reflects the situation faced by a trader who does not have sufficient credit to get the best liquidity from our dealer universe and thus needs to pick an average quote for the required deal size.

The fourth scheme (MIN) starts in a similar manner, but instead of calculating the average cost across all participating banks, it takes the lowest cost. The cost computed in this manner is typical for a trader who has good business relationships and sufficient credit standing with all bank dealers and thus can act on the best dealer quote provided by the banks for any deal size at any moment in time.

According to aspects of the invention, an end user can either utilize the cost applicable to a particular trading situation, or compare the costs computed under different consolidation assumptions. This comparison can yield a better understanding of the cost of liquidity across different scenarios for a particular currency pair. FIGS. 6A, 6B and Table 1 at the end of this section illustrate how the different limit order book consolidation schemes affect resulting cost estimates.

Other objects, advantages and features of the invention that may become hereinafter apparent, the nature of the invention may be more clearly understood by reference to the following detailed description of the invention, the appended claims, and the drawings attached hereto.

### BRIEF DESCRIPTION OF THE DRAWINGS

FIG. 1 is a block diagram of an exemplary system for facilitating currency exchange, according to aspects of the present invention.

FIG. 2 illustrates exemplary electronic indicative quotes and electronic tradable quotes for a currency pair that is being traded.

FIG. 3 illustrates an exemplary process for calculating a trading cost, according to the present invention.

FIGS. 4A-4B illustrate an exemplary cost curve, according to the present invention system.

FIGS. 5A-5B illustrate exemplary cost curves, according to an embodiment of the present invention.

FIGS. 6A-6B illustrate exemplary cost curves, according to an embodiment of the present invention.

FIG. 7 illustrates steps of the exemplary process for calculating a trading cost, according to the present invention.

FIGS. 8A-8B illustrate adjustment to a cost curve based on volatility, according to an embodiment of the present invention.

FIG. 9 illustrates variability in pre-trade cost estimates during a period of weeks, according to the present invention.

FIG. 10 illustrates cost curves as a function of time, according to the present invention.

FIG. 11 illustrates removal of an order from an order book, according to the present invention.

FIGS. 12A and 12B illustrate removal of an order from an order book, according to the present invention.

### DETAILED DESCRIPTION OF THE INVENTION

The present invention relates to network communications systems and methods that include a network communications interface for sending and receiving signals to and from a plurality of different electronic trading venues. The network communication interface if configured to extract electronic data from signals received according to the appropriate communications protocols. From the data, the system is capable of calculating foreign exchange (FX) trading cost, and more specifically to calculating a trading cost associated with trading a currency pair (i.e., trading a first currency for a second currency). The trading cost may be incurred because of the spread between a bid price and ask price. For instance, the purchase price (i.e., ask price) for a currency may always be higher than the sale price (i.e., bid price) for the currency. Thus, a trader that buys a certain amount of the currency incurs a loss unless the currency appreciates in value by a sufficient amount. Thus, the ask/bid spread represents a cost to the trader. In an embodiment, a trading cost may be calculated as a half-spread (i.e., half the difference between an electronic ask quote and an electronic bid quote). More specifically, the calculation may be performed as a difference between an electronic midquote and one of the ask quote and bid quote. The electronic midquote is a value that is midway between the electronic ask quote and the electronic bid quote. In an embodiment, the trading cost may be expressed in units of basis points or percentage in points (pips).

Although trading cost can be determined by comparing a rate of an executed trade versus a high rate or low rate for a particular time period (e.g., for the day), such a determination can be performed only in a post-trade setting.

In a pre-trade setting, although estimation of trading cost may be performed with an electronic indicative quote (i.e., a non-binding quote that a market maker provides to a trading party, a quote from a source such as Yahoo finance, etc.), indicative quotes (iQ) tend to exhibit a large ask/bid spread. Often, this ask/bid spread may be larger than an ask/bid spread of the actual tradable quote (i.e., a firm quote in which a market maker guarantees a specified bid price or ask price). Thus, the electronic indicative quote may tend to overestimate the trading cost for small trades. For large trades, the indicative quote may lead to underestimation of the trading cost.

Additionally, during periods that experience change in market volatility, indicative quotes are often not updated as quickly as tradable quotes. As discussed in more detail below, this lag may cause an underestimation of trading cost.

The present invention relates to network communication systems in an electronic trading marketplace, that can estimate trading cost based on electronic data describing price quotes (e.g., dealer quotes) from various electronic trading venues that trade a first currency for a second currency. Such electronic trading venues may include global banks and major electronic communication networks (ECNs). These electronic price quotes provide a basis for calculating an estimated trading cost. The present invention further recognizes that a trader may not have access to each bank, ECN, or other liquidity source for trading a currency pair. For instance, global banks may trade currency only with other global banks or large institutional investors, thus removing such banks as a liquidity source for other market participants. The present invention also relates to estimating at least two different trading costs. A first trading cost may assume that a market participant has access to all available electronic trading venues, including all the global banks and ECNs. Accordingly, the first trading cost may be calculated based on electronic dealer quotes from all of the electronic trading venues. A second trading cost may assume that a market participant has access to only a subset of the available electronic trading venues, such as to only ECNs. Accordingly, the second trading cost may be calculated based on only electronic dealer quotes from the ECNs.

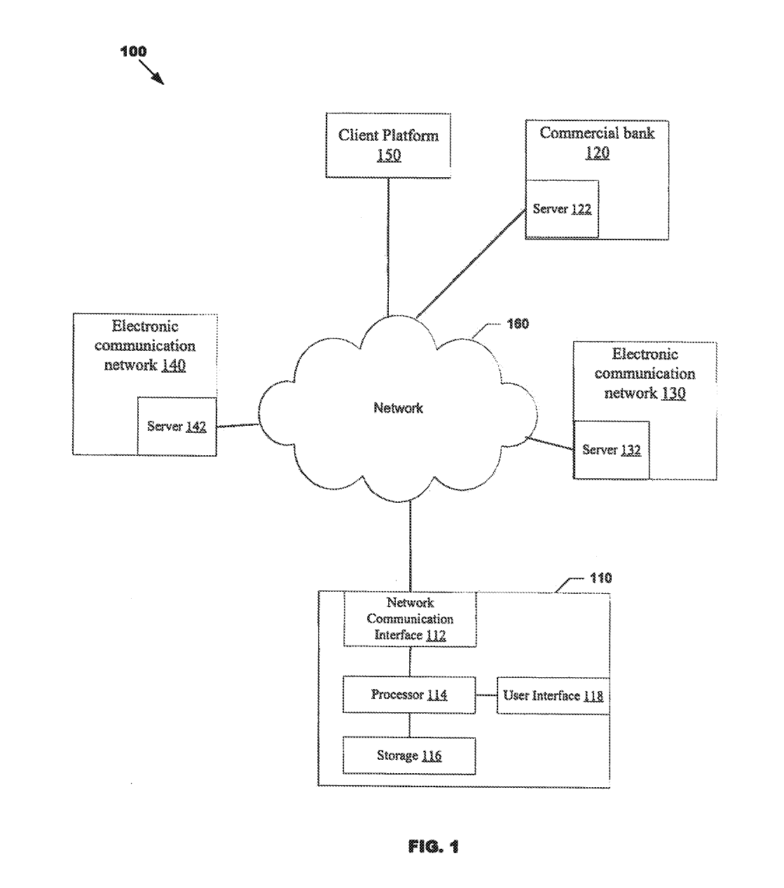

FIG. 1 is a high-level block diagram illustrating an environment 100 in which a network communication system 110 is configured to facilitate FX transactions by calculating a trading cost for such transactions, according to an embodiment of the present invention. The environment 100 may include system 110 communicating over a network 160 with a plurality of electronic trading venues that trade various currency pairs. The electronic trading venues may include a commercial bank 120, an ECN 130, and an ECN 140. Each electronic trading venue may have a server 122, 132, 142, respectively, configured to communicate over the network 160. In particular, the servers 122, 132, 142 may be configured to send electronic dealer quotes of their respective electronic trading venues to system 110 via network 160.

System 110 may include a network communication interface 112, a storage device 116, a user interface 118, and a processor 114 in communication with the three components. The network communication network interface 112 may receive signals from electronic trading venues and electronic traders, and other electronic devices in the environment. Some of the signals may represent information about electronic dealer quotes from one or more of the bank 120, ECN 130, and ECN 140. The network communication interface extracts this information about dealer quotes, which may be passed to processor 114, which may use the electronic quotes to generate one or more cost curves.

The storage device 116 may include a non-transitory computer readable medium that stores one or more instructions for causing the processor 114 to perform the steps discussed herein.

The network communication interface 112 may further receive signals representing an electronic trade order from client platform 150 (e.g., an trader's server computer) to trade a first currency for a second currency. The processor 114 may calculate one or more trading costs for the order, and may return the one or more costs to the client platform 150 via the network communication interface 112.

The system 100 preferable includes a plurality of network addressable computing devices capable of receiving electronic signals from disparate sources, the electronic signals representing electronic data, which is extracted and used according to the systems and methods described herein. Such systems are typically not off the shelf PC's but instead, the skilled person will recognize that powerful, multiport network servers are preferred. System 100 should be configured to perform network communication using communications protocols such as FIX and other employed by electronic trading venues.

The ECNs may each include a computer system that facilitates trading of financial products (e.g., currencies) outside of stock exchanges. In an embodiment, the ECN may receive sell orders and buy orders directly from various traders and may internally match such orders. The ECNs may also be referred to as alternative trading systems (ATSs).

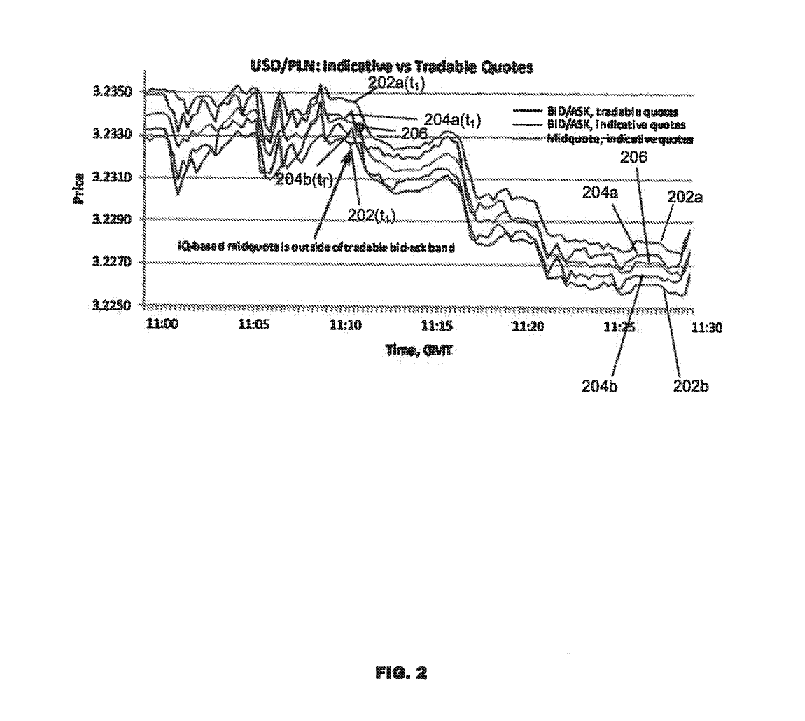

As discussed above, using electronic indicative quotes to estimate trading cost may cause an overestimation of the trading cost in some cases and an underestimation of the trading cost in others. FIG. 2 illustrates the use of indicative quotes to estimate trading cost for trading $2 million between the US dollar and the Polish Zloty (USD/PLN) at 11 AM (trading cost tends to vary throughout the day). In FIG. 2, curve 202a represents an indicative ask quote as a function of time, while curve 202b represents an indicative bid quote as a function of time. That is, curve 202a represents non-binding prices provided to a market participant for purchasing US dollars with Polish Zloty, while curve 202b represents non-binding prices provided to a market participant for selling US dollars in exchange for Polish Zloty. A curve 206 represents an indicative quote (iQ)-based midquote, which may be a middle value between the indicative ask quote and the indicative bid quote.

The indicative quotes in FIG. 2 are compared against tradable quotes, which represent a guaranteed price at which a currency exchange is to take place or has taken place. For instance, curve 204a represents a guaranteed price (in Polish Zloty) at which a trader can buy US dollars, and curve 204b represents a guaranteed price (in Polish Zloty) at which a trader can sell US dollars.

As FIG. 2 illustrates, the bid/ask spread calculated from electronic indicative quotes may often be wider than that calculated from the eventual electronic tradable quotes for such a trade. At certain instances in time (e.g., right after 11:10), the difference between the indicative quotes and the tradable quotes may be substantial. Such a difference between the indicative quotes and the tradable quotes may lead to overestimation of trading cost for smaller trade sizes, and underestimation of trading cost for larger trade sizes.

Additionally, electronic indicative quotes may not be updated as fast as electronic tradable quotes. During periods of change in market volatility, indicative quotes may thus become too outdated to yield an accurate estimate of trading cost. For example, FIG. 2 shows that, at time t=t₁, the electronic tradable quotes may drop in price due to change in market volatility (e.g., caused by a politically-related or macroeconomic event), but the electronic indicative quote at t₁ may not react as quickly. As a result, at t=t₁ (e.g., at 11:11 AM), the iQ-based midquote may fall outside the range formed by the more-quickly-reacting tradable quotes 204a(t=t₁) and 204b(t=t₁). Such an occurrence may cause an underestimation of trading cost. For example, if PLN were traded at the iQ-based midquote at 11:11 AM, such a sale might be considered a success when compared against the indicative quotes. When compared against the tradable quotes, however, the trade lost over 1 basis point. Thus, use of the indicative quotes may lead to an inaccurate estimation of trading costs.

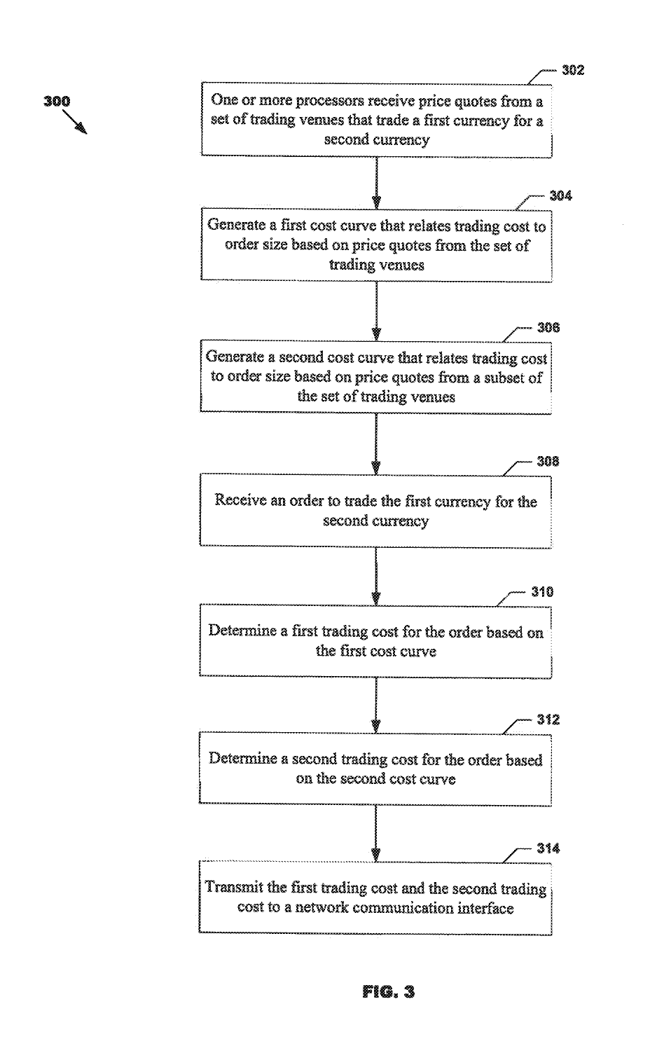

FIG. 3 shows a flow diagram that illustrates a more optimal method 300 for estimating trading cost. The method involves calculating trading costs based on electronic price quotes from different sets of liquidity sources. In the illustrated embodiment, method 300 begins at step 302, in which one or more processors (e.g., processor 114 of system 110) receive electronic price quotes (e.g., a network communications interface receives signals representing the data and extracts the data from the signals) from a set of electronic trading venues (e.g., bank 120, ECN 130, ECN 140) that trade a first currency for a second currency. In an embodiment, the electronic price quotes may be tradable quotes. In an embodiment, the set of electronic trading venues may represent all available electronic trading venues that trade the first currency for the second currency. In an embodiment, the electronic price quotes from the set of electronic trading venues may be received at a consolidated limit order book maintained on, for example, storage device 116 of system 110.

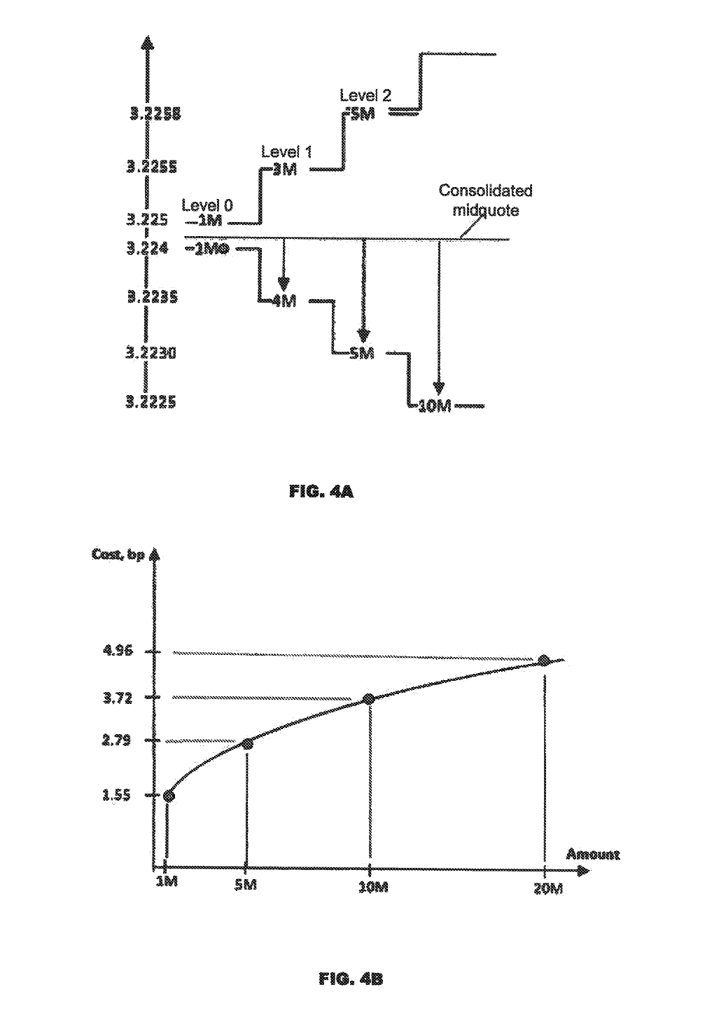

In step 304, the one or more processors generate electronic data representing a first cost curve (ALL) based on electronic price quotes from the set of electronic trading venues. In an embodiment, the cost curve relates trading cost to order size. In other words, the cost curve represents trading cost as a function of order size. Generating the cost curve is discussed in more detail below, with respect to FIGS. 4A-4B.

In step 306, the one or more processors generate electronic data representing a second cost curve (CECN) that also relates trading cost to order size. However, the second cost curve is based on electronic price quotes from only a subset of the set of electronic trading venues. For instance, the second cost curve may be based on electronic price quotes from only ECNs (e.g., ECN 130 and ECN 140). The second cost curve may represent a higher trading cost for a trader who does not have access to all the available banks, ECNs, and other electronic trading venues that trade a particular currency pair. In some cases, the trader may not engage in the volume of trading that is required to trade with commercial banks or other such liquidity sources. Compared with the first cost curve, the second cost curve may represent a more conservative estimate of trading cost. The first cost curve, on the other hand, may assume that a trader who
is patient and resourceful enough to search for the liquidity available on different electronic trading venues, and/or
has credit standing sufficient to access all liquidity from participating banks.
   The first cost curve may thus represent a more optimistic estimate of trading cost, and may be viewed as a lower limit on trading cost. The first cost curve and the second cost curve may thus reflect different trading styles and credit tiers of a trader or other market participant.

Two other curves can be generated that do not involve limit order book consolidation across different trading venues. Both of these curves rely on the liquidity available from a single bank dealer. The third curve (AVG) computes the cost of climbing the limit order book of each dealer bank separately, and then calculates the average cost (across banks) for a given trade quantity. The cost computed in this manner reflects the situation faced by a trader who does not have sufficient credit to get the best liquidity from our dealer universe and thus needs to pick an average quote for the required deal size. The fourth curve (MIN) starts in a similar manner, but instead of calculating the average cost across all participating banks, it takes the lowest cost. The cost computed in this manner is typical for a trader who has good business relationships and sufficient credit standing with all bank dealers and thus can act on the best dealer quote provided by the banks for any deal size at any moment in time.

In step 308, the one or more processors may receive an electronic trade order (e.g., from client platform 150) to trade the currency pair (i.e., to trade the first currency for the second currency). In step 310, the one or more processors determine a first trading cost for the order based on the first cost curve. In step 312, the one or more processors determine a second trading cost for the order based on the second cost curve. In an example, both the first trading cost and the second trading cost may be determined by finding a value on the first cost curve and a value on the second cost curve, respectively, that corresponds to the order size. For some traders (e.g., those having access to more sources of liquidity), the first trading cost may better reflect their capability and access to FX liquidity, while the second trading cost may be more relevant for other traders. Similarly, third and fourth trading costs can be determined from the third and fourth cost curves.

In step 314, the one or more processors transmit the trading costs to a network communication interface (e.g., network communication interface 112), which may in turn transmit the trading costs to a client platform (e.g., client platform 150).

FIGS. 4A-4B illustrate the calculation of a cost curve by consolidating price quotes for a currency pair across multiple electronic trading venues. For example, the curve being constructed in FIGS. 4A-4B may be generated based on electronic price quotes from all available electronic trading venues for the currency pair.

As FIG. 4A illustrates, across all electronic trading venues, 1 min US dollars has been quoted with an asking price of 3.225 PLN and a bid price of 3.224. There is further liquidity across the electronic trading venues, but at a higher spread. For instance, FIG. 4A illustrates that the set of electronic trading venues has an additional 3 min US dollars that are offered at the higher ask price of 3.2255 PLN and sought at the lower bid price of 3.2235 PLN. The ask/bid spread may thus be calculated from the electronic price quotes for different order sizes.

In an embodiment, the electronic price quotes may be received at a limit order book, which may consolidate the electronic price quotes from the different electronic trading venues. The limit order consolidation may be done on a tick-by-tick basis. For instance, the limit order book may be empty every midnight, and may add ask/bid messages as they arrive and remove such messages as they are removed from the book. Each time a new ask/bid message arrives or is deleted, the trading cost is calculated, thus providing for an instantaneous update of the trading cost.

As an example, the instantaneous trade cost for a buy trade of amount S may be calculated using the formula:

$$Cost ( S ) = \frac{1}{s} {\sum }_{l = 0}^{{l}_{s}} {depth}_{l} \cdot ( MQ - {PRICE}_{i} )$$

where
lₛ is the last level in the book that was reached while filling an electronic trade order of size S (l=0 is the best level in the book),
depthᵢ is the amount available in the limit order book at level l, and
(MQ−PRICEᵢ) is the l-th level's distance from the prevailing consolidated midquote.

The above parameters are illustrated in FIG. 4A. As an example, the trading cost for a 9 min buy order for USD/PLN may be calculated, based on the illustrative values in FIG. 4A, as:

$$\frac{1}{9 million} ( 1 million ( 3.2245 - 3.225 ) + 3 million ( 3.2245 - 3.2255 ) + 5 million ( 3.2245 - 3.2258 ) )$$

The cost curve may be generated by varying the quantity S (e.g., between 0.5 min USD and 20 min USD) and calculating the trading cost for each such quantity. In an embodiment, trading cost for certain quantities S may be interpolated and, for less liquid pairs, extrapolation beyond price levels available in the limit order book may be used.

An example cost curve is illustrated in FIG. 4B. The final cost numbers, in basis points (bp), are calculated with the above formula, and are then divided by the midquote value of 3.2245 and then multiplied by 10,000.

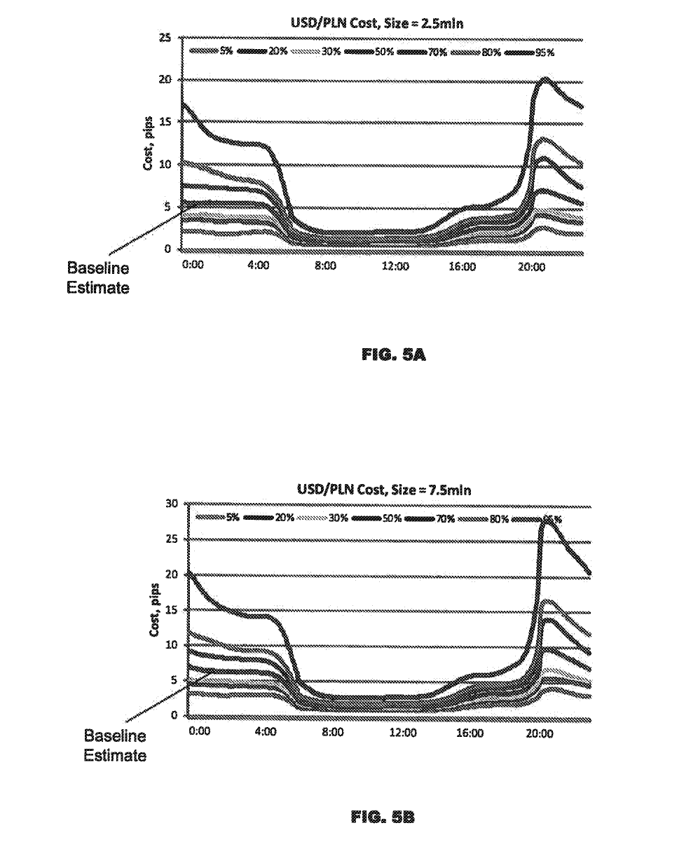

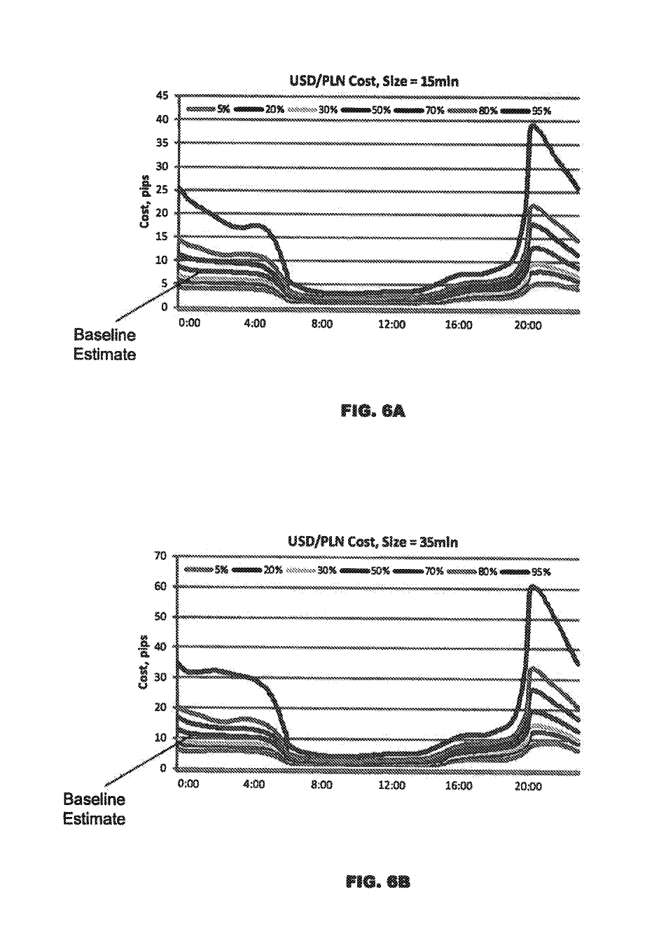

Once the trading cost is calculated for different trade amounts, it may be aggregated into bins of a certain interval (e.g., 15-sec bins), and a distribution across a certain time period (e.g., the last 60 days) may be calculated. In an embodiment, to reflect to intraday pattern in depth and spread for the cost model, the cost distribution is computed for every 15-sec bin, for a total of 5760 fifteen-second bins per day. The median of the distributions in every bin may be considered a baseline estimate of trading cost. FIGS. 5A-5B and FIGS. 6A-6B illustrate the intraday pattern of the instantaneous trading costs for four different order sizes for the USD/PLN currency pair.

As FIGS. 6A-6B illustrate, the baseline estimates of trading cost are quite stable over time. Thus, in an embodiment, the baseline estimates may be used to represent the trading cost on an average day.

However, a cost curve, such as one being used as a baseline estimate of trading cost, may be affected by changes in market volatility. For example, macroeconomic news announcements may often cause significant deviations from baseline estimates. To take market volatility into account, a cost curve may be adjusted based on an indication of the volatility.

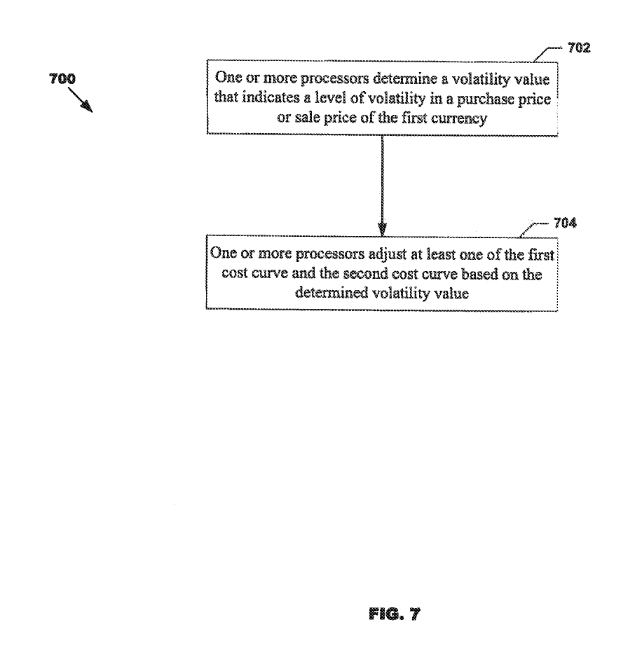

FIG. 7 illustrates a process 700 for adjusting a cost curve based on market volatility. In an embodiment, process 700 begins at step 702, in which one or more processors determine a volatility value that indicates a level of volatility in a purchase price or sale price of a first currency. In an embodiment, the volatility value may be derived from electronic data (e.g., a network communications interface may receive signals representing the data and extract the data from the signals) describing a currency option contract (e.g., currency option with one-month maturity). The price in such currency option contract may provide an indication of expected price movements.

In step 704, the one or more processors adjust at least one of the first cost curve and the second cost curve based on the determined volatility value. For instance, if the volatility value indicates an upward trend in the implied volatility in a market, the cost curve may be adjusted upward. If, on the other hand, the volatility value indicates a downward trend in the implied volatility, the cost curve may be adjusted downward. The implied volatility refers to a value of an option contract that reflects a volatility of an underlying instrument of the contract.

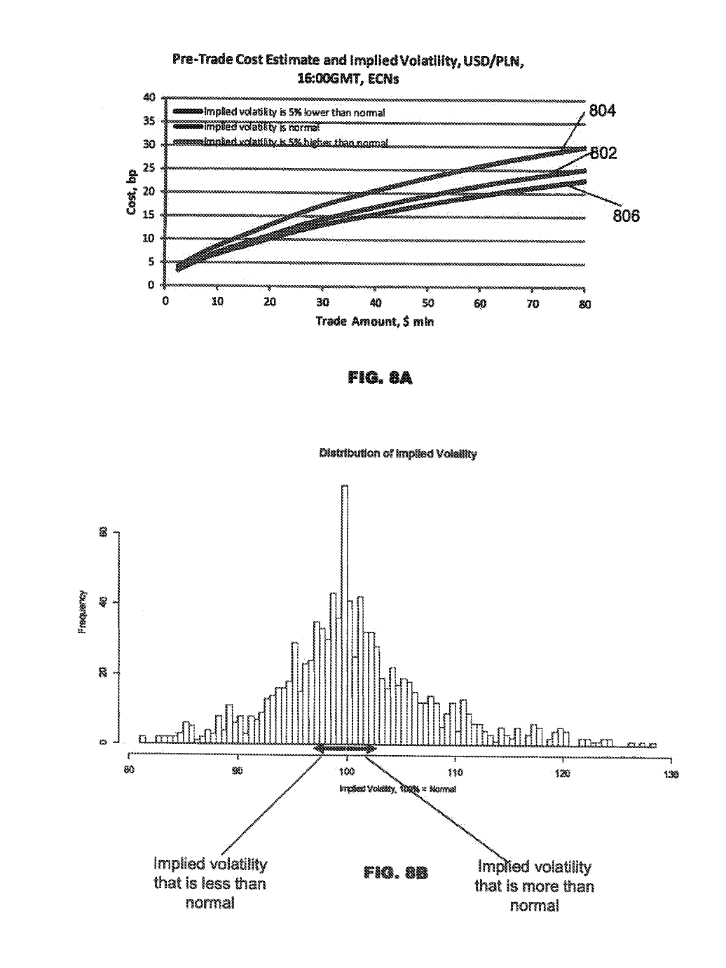

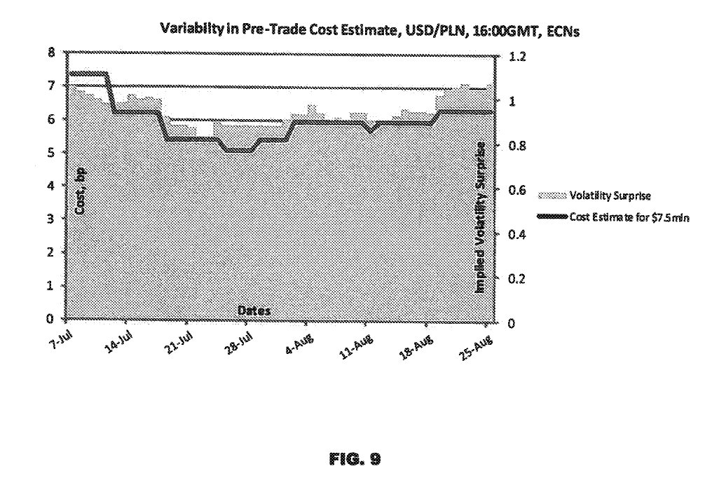

As an example, FIGS. 8A-8B illustrate an adjustment for a cost curve that represents trading cost for a USD/PLN currency pair. As FIG. 8 illustrates, a baseline cost curve 802 may be adjusted by 1.8 basis points, resulting in cost curve 804, if a volatility value shows an implied volatility that is 5% higher than an initial (e.g., “normal”) level of volatility. The baseline cost curve 802 may be adjusted by −0.6 basis points, resulting in cost curve 806, if a volatility value shows an implied volatility that is less than the initial level of volatility. FIG. 8B provides a histogram that illustrates a range of implied volatility. The chart combines daylight savings time (DST) and non-DST periods for all pairs to account for market open/close times and other intraday seasonal effects. The chart demonstrates the frequency and magnitude of changes in implied volatility that may be experienced.

FIG. 9 illustrates a relationship between market volatility and change in trading cost for a $7.5 min trade order for the USD/PLN currency pair at 16:00 GMT for a plurality of different days. As the figure shows, the variation in trading cost closely follows changes in implied volatility in the market. In the figure, the implied volatility is normalized (i.e., the value of 1 denotes “normal” volatility).

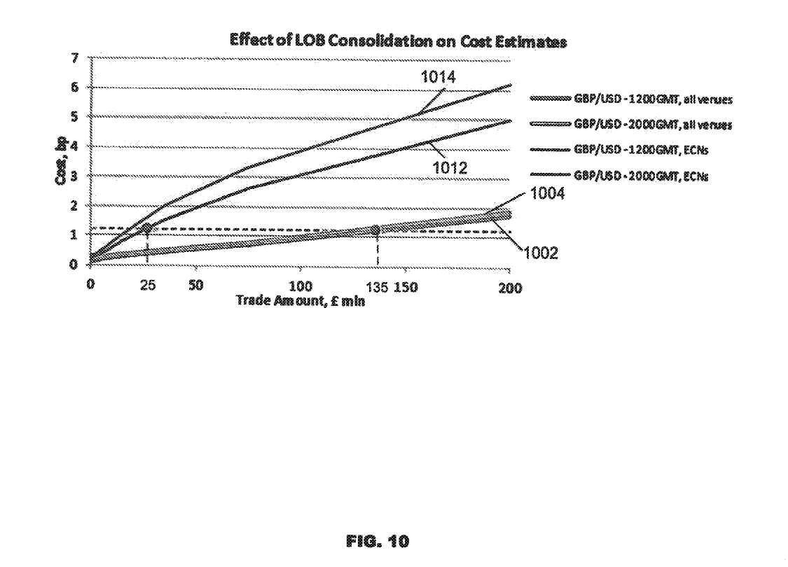

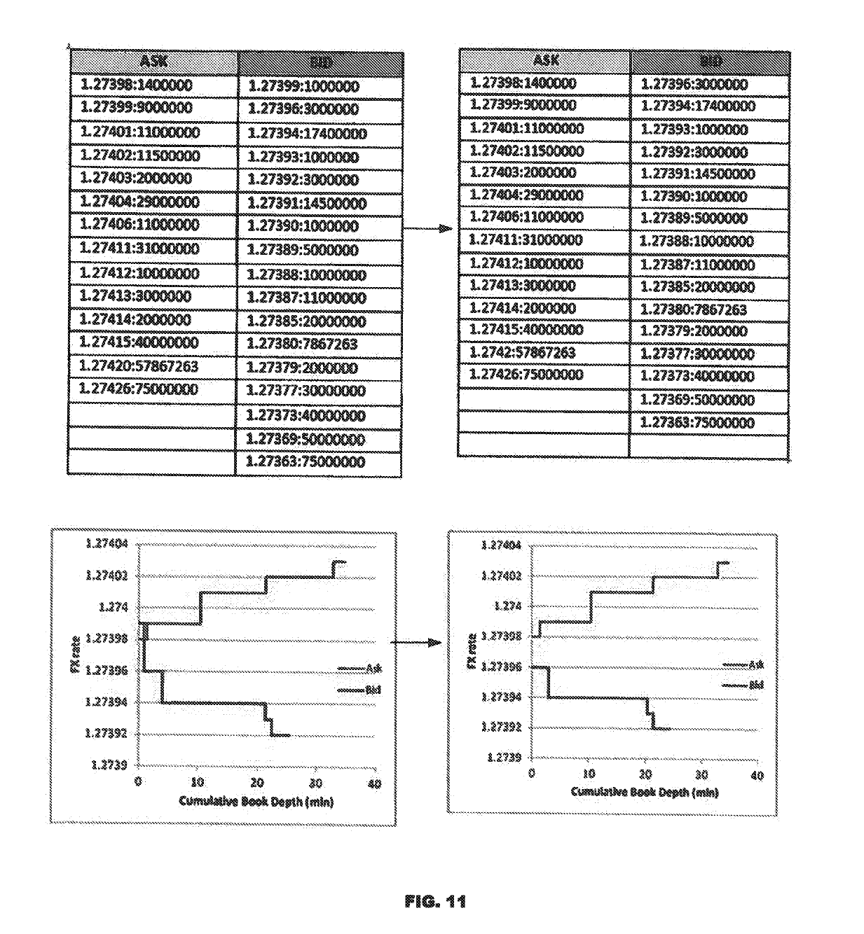

FIG. 10 illustrates a cost curve for another currency pair, GBP/USD, at two different times of day and for two different sets of electronic trading venues. A good FX cost model should reflect intraday patterns in spread and market depth, as well as cross-sectional differences between the available liquidity of different currency pairs. In addition, the model should respond to changing market conditions and adjust the cost estimates accordingly.

The cost curves in FIG. 10 include:
a cost curve 1002 for the GBP/USD currency pair at 12:00 GMT, across all available electronic trading venues that trade the currency pair;
a cost curve 1004 for the currency pair at 20:00 GMT, across all available electronic trading venues that trade the currency pair;
a cost curve 1012 for the currency pair at 12:00 GMT, across only available ECNs that trade the currency pair
a cost curve 1014 for the currency pair at 20:00 GMT, across only available ECNs that trade the currency pair.

The cost curves reflect costs at 12:00 GMT and 20:00 GMT under normal volatility conditions. In some instances, trading cost is generally lower at 12:00 GMT than at 20:00 GMT because liquidity for a currency pair tends to be higher at 12:00 GMT. At 20:00 GMT, after the London currency exchanges close, liquidity generally decreases, and trading cost, in the form of the ask/bid spread, tends to increase.

For instance, as shown by cost curves 1012 and 1014, there is a difference of about 0.5 basis points between trading cost for a £50 min trade at 12:00 GMT versus the same trade at 20:00 GMT. This difference represents almost ⅓ of the entire trading cost at 12:00 GMT.

FIG. 10 further illustrates again the role of the two cost curves as representing an upper bound and a lower bound for trading cost. For instance, for trading £50 min of the GBP/USD currency pair at 12:00 GMT, cost curve 1012 represents the upper bound (1.95 basis points) for a trading cost that is based on electronic price quotes from only ECNs, while cost curve 1002 represents the lower bound (0.53 basis points) of the trading cost based on electronic price quotes from all available electronic trading venues for the GBP/USD pair.

Finally, FIG. 10 illustrates the advantage of using the cost curve over the electronic indicative quotes in estimating trading cost. In FIG. 10, electronic indicative quotes may be used to estimate a trading cost of about 1.25 bps. However, the cost curve 1002 shows that a trader may actually reach £135 min in trades before reaching the iQ-based trading cost, while a more conservative estimate with cost curve 1004 shows that a trader may reach £25 min while remaining within the iQ-based trading cost. The cost curves 1002 and 1004 may thus allow a trader to discover that a market has additional liquidity, and that additional trades may be conducted for a currency pair while still staying less than an iQ-based trading cost.

Example cost estimates across different currency pairs under normal volatility conditions are illustrated in Table 1. The cost estimates are for a trade size of 50 million, and are reported in units of bps.

TABLE 1
Example cost estimates for various currency pairs

| | Cost | Cost | Cost | Cost |
|---|---|---|---|---|
| Pair | ALL | MIN | AVG | ECN |
| Majors | | | | |
| EUR.USD | 0.3 | 0.5 | 0.9 | 0.6 |
| USD.JPY | 0.5 | 0.7 | 1.3 | 1.4 |
| GBP.USD | 0.4 | 0.6 | 0.9 | 0.8 |
| USD.CHF | 0.8 | 1.0 | 3.8 | 5.0 |
| AUD.USD | 0.8 | 1.1 | 2.0 | 2.3 |
| USD.CAD | 0.8 | 1.1 | 2.0 | 2.1 |
| NZD.USD | 2.0 | 2.5 | 5.5 | 6.4 |
| Major Crosses | | | | |
| AUD.CAD | 1.6 | 2.2 | 3.5 | 4.2 |
| AUD.JPY | 1.4 | 2.0 | 3.5 | 3.9 |
| AUD.NZD | 2.1 | 2.8 | 5.4 | 6.3 |
| CAD.JPY | 1.4 | 2.1 | 3.7 | 4.1 |
| GBP.AUD | 0.9 | 1.4 | 2.3 | 2.0 |
| GBP.CAD | 1.1 | 1.8 | 2.9 | 3.0 |
| GBP.JPY | 0.9 | 1.5 | 2.5 | 2.5 |
| EUR.AUD | 0.8 | 1.3 | 2.3 | 2.0 |
| EUR.GBP | 1.0 | 1.6 | 2.5 | 2.0 |
| EUR.JPY | 1.2 | 1.8 | 5.4 | 6.5 |
| EUR.CHF | 0.6 | 0.8 | 1.5 | 1.5 |
| EUR.CAD | 0.7 | 0.8 | 1.7 | 2.0 |
| Exotic Pairs | | | | |
| AUD.HKD | 1.0 | 1.7 | 2.6 | 2.7 |
| EUR.DKK | 0.2 | 0.5 | 1.0 | 0.5 |
| EUR.HUF | 5.3 | 6.3 | 10.0 | 11.8 |
| EUR.ILS | 5.8 | 7.5 | 11.3 | 11.3 |
| EUR.NOK | 2.7 | 4.2 | 6.2 | 5.5 |
| EUR.PLN | 3.4 | 4.4 | 6.6 | 6.8 |
| EUR.SEK | 2.5 | 3.8 | 5.7 | 5.2 |
| EUR.ZAR | 4.2 | 5.7 | 8.7 | 7.5 |
| USD.DKK | 0.9 | 1.0 | 3.1 | 4.1 |
| USD.HKD | 0.1 | 0.2 | 0.3 | 0.3 |
| USD.HUF | 5.3 | 5.8 | 11.2 | 15.8 |
| USD.ILS | 5.5 | 6.3 | 9.5 | 10.9 |
| USD.MXN | 3.7 | 4.1 | 8.8 | 11.9 |
| USD.NOK | 2.5 | 3.4 | 5.4 | 5.9 |
| USD.PLN | 3.2 | 3.8 | 8.1 | 10.6 |
| USD.SEK | 2.3 | 3.1 | 5.0 | 5.4 |
| USD.SGD | 1.5 | 1.9 | 2.9 | 2.9 |
| USD.TRY | 2.6 | 3.2 | 5.9 | 7.2 |
| USD.ZAR | 3.7 | 4.4 | 6.6 | 6.1 |

Several observations follow from the table. First, the costs are lowest for major pairs, followed, in increasing order, by major crosses and exotic pairs. The median costs assuming consolidation across all venues (ALL) are 0.8, 1.1 and 2.7 bps for majors, major crosses and exotic pairs, respectively. The medians which assume the average cost across all dealer banks (AVG) are 2.0, 2.7 and 6.2, respectively. Second, the magnitude of the difference between the ALL and AVG cost bounds for most pairs appear to indicate that dealer banks give their direct clients better rates than the rates they send to ECNs. Recall that the ALL cost bound is linked to the limit order book consolidated across all venues (dealer banks and ECNs), and the AVG cost bound corresponds to climbing the limit order book consolidated only across ECNs. Since ECNs do receive tradable quotes from dealer banks, it might indicate preferential pricing on part of the latter.

Order Book Management

A foreign exchange (FX) limit order book may be managed through a FX daily production process that occurs in five stages: 1) splitting of a flat file that contains quote messages from major ECNs and dealers (FLX file); 2) conversion of FX market data provider's messages to FLX format; 3) filtration of files on a provider level; 4) merging of all providers; and 5) running of a quality assurance (QA) process. The order book, after the merging of the providers (e.g., a network communications interface may receive signals representing the data from the providers and extract the data from the signals), may have the following format: rate log time, rate identifier, mode, side, provider ID, source ID, rate ID, settlement date, rate timestamp, size, minimum size, outright rate, spot rate, forward rate, whether the order is executable, whether the order is last dealt. The fields of side, provider ID, source ID, rate ID, size, minimum size, outright rate, spot rate, forward rate, is_executable, and is_last_dealt may be used to match add messages with delete messages, and to distinguish duplicate messages for the filtration of files. Such fields may be matched with the settlement date and rate timestamp fields. The latter two fields may be necessary for certain providers because the rate ID for such providers are not sufficiently unique.

1. Splitting of FLX File

The splitting of a FLX file may involve reading through a FLX file and separating each line based on a provider ID for that line. Lines involving Dealer X (DX) may be processed such that the rate timestamp for a given rate and size are equivalent to the rate log time for adds, or equivalent to the rate log time of the oldest unpaired add with the same rate and size for deletes. These DX lines are then recombined with non-DX lines, and are sorted by rate log time. This is done to account for instances where DX's quote messages do not have sufficient information to pair add messages with deletes, nor to distinguish duplicate messages.

2. Conversion of FX Market Data Provider's Messages

The conversion of FX Market Data Provider's messages may involve the FX Market Data files, which may have been provided daily. The files may include three files that describe real time quotes, indicative quotes, and trades, respectively. Indicative quotes are treated as un-executable FLX quotes with size 1. As above, these three files are split out into a single separate file for each currency pair.

3-4. Filtering of Files and Merging of all Providers

The filtering step may involve reading through each file by currency and provider, and 1) removing decimal values for all sizes; 2) filtering messages with size=0 or rate=0; 3) filtering delete messages that have no associated add message; 4) filtering duplicate add/delete messages; and 5) marking add messages as stale if there is no associated delete message found by the end of the week.

With respect to step 5), an add message is associated with a delete message (and vice versa) if they share the following information: side, provider, subprovider, rate ID, size, minimum size, outright rate, spot rate, and forward rate. A message is considered a duplicate if there already exists a message with the above information for the same type (add or delete).

A filtering script may keep a record of the total number of messages, filtered messages, and stale messages by pair and provider, which are then loaded into the database for quality assurance testing.

5. Quality Assurance (QA) Testing

The QA process may involve loading message counts by currency, and provider, and performing a stability check. Specifically, the process checks to ensure that the number of total messages, filtered messages, and removed messages do not differ by more than two standard deviations from their mean. For example, it will make sure that the message counts for EUR.USD for a particular day do not differ more than two standard deviations from the mean of message counts for EUR.USD for all days in the previous 52 weeks (1 year).

Building Order Book

A limit order book may be built through received quote messages. The order book may be printed at every timestamp at which the book changes. In one example, a non-transitory computer-readable medium may include instructions that, when executed by one or more processors, build the limit order book in a database (e.g. SYBASE, Oracle, etc.) or in a flat file system. The instructions may cause the one or more processors to remove bad messages based on the filtering steps described above, so that the order book is neither crossed nor locked on a consolidated ECN and consolidated dealer level.

In a more specific example, when the book becomes crossed (e.g., locked), the one or more instructions may cause the one or more processors to remove the following for as long as the book remains crossed/locked (and continuing on if both sides are tied):

a. All stale quotes: as discussed above, a stale quote is an add quote which does not have a corresponding delete by the end of the day.

b. The best level with a single blacklisted provider. The blacklisted providers are, for example, VRT, FXALL, and OTHER6, which have been identified as problematic providers in causing crossed books.

c. The best level that crosses the most levels (that have been updated in the last thirty seconds) on the other side.

d. The best level with the least number of liquidity providers.

e. The best level with size less than 1 million.

f. Both best levels, adding their size to the next best level on their respective sides.

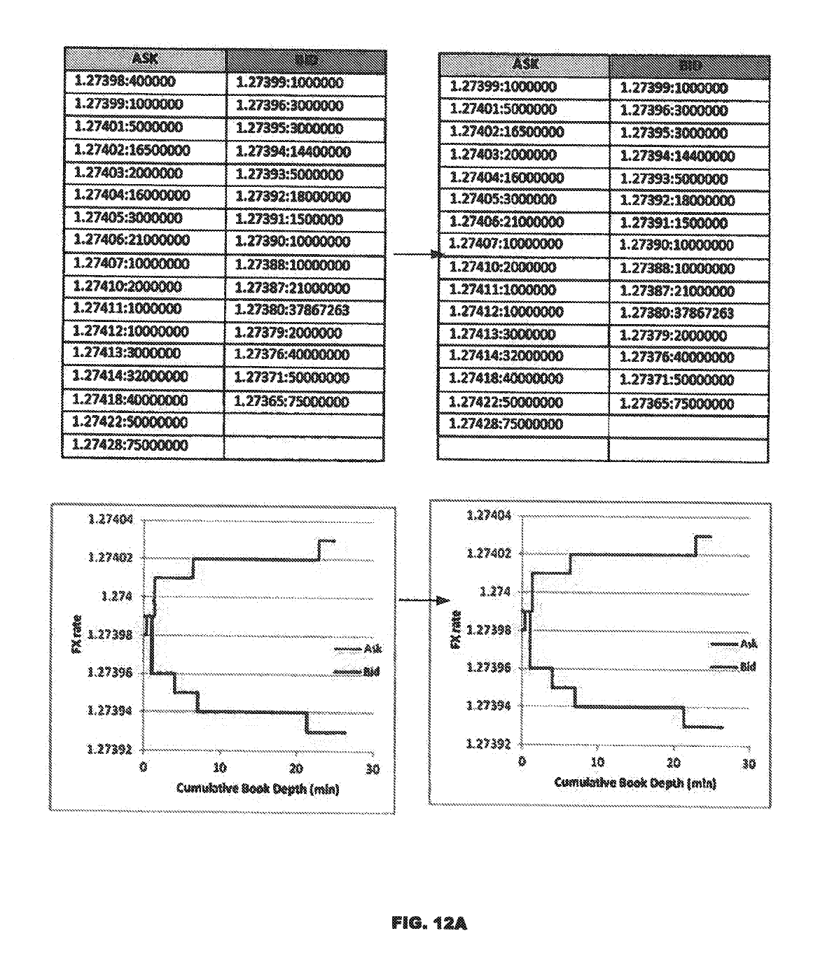

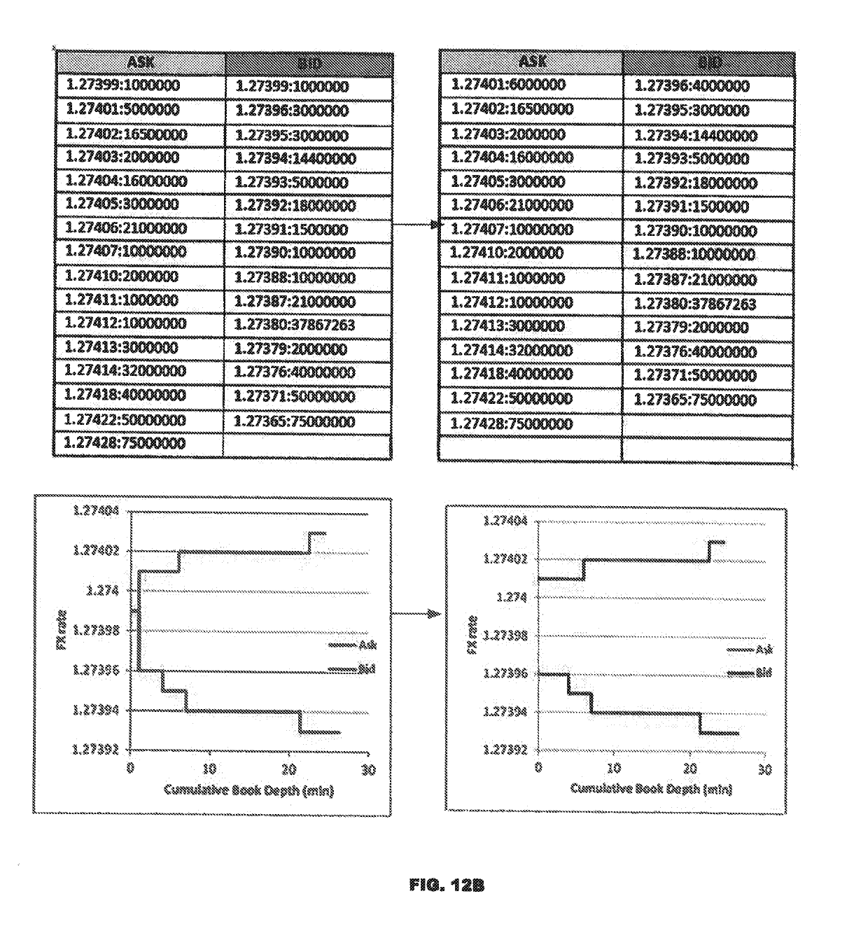

The removal process is illustrated in two examples in FIGS. 11 and 12A-12B. FIG. 11 illustrates an example in which the best ASK quote crosses/locks one level on the bid side, while the best BID quote crosses/locks two levels on the ask side. Based on the rules above (e.g., rule c), the best BID quote of 1.27399 is removed.

In the example illustrated in FIGS. 12A-12B, the best ASK quote has a size less than 1 million. Based on rule e, the best ASK quote is removed in a first pass. In the second pass, there is a tie: both the best ASK quote and the best BID quote cross/lock one level on the other side. As a result (based on rule f), both of the quotes are removed.

The skilled person will understand that the operations and processes described herein can be effected with specific combinations of hardware and software suitably selected for high-speed, low-latency network communications and exchange trading. Aspects of the invention may be programmed with suitable programming language for high-speed, large-scale processing, and may include C, C++, JAVA, etc.

Thus, the present invention has been fully described with reference to the drawing figures. According to aspects of the present invention, systems and methods have been provided by which FX trading cost may be calculated based on different sets of electronic trading venues and based on indications of change in volatility.

Although the invention has been described based upon these preferred and exemplary embodiments, it would be apparent to those of skilled in the art that certain modifications, variations, and alternative constructions would be apparent, while remaining within the spirit and scope of the invention. In order to determine the metes and bounds of the invention, therefore, reference should be made to the appended claims.

Further nonlimiting aspects and examples of the present invention are detailed in the attached Exhibit A, which is incorporated herein by reference.

### Exemplary Embodiments of the Present Disclosure

One embodiment of the present invention involves a computerized method executed by one or more processors for electronically calculating currency exchange trading cost. The method includes:
a) receiving, at the one or more processors, electronic data (e.g., a network communications interface receives signals representing the data and extracts the data from the signals) indicating price quotes from a set of electronic trading venues that trade a first currency for a second currency and that provide electronic quotes, the electronic data being received from a network communication interface in communication with the one or more processors;
b) generating, at one or more processors, a first cost curve that relates trading cost to order size for a plurality of order sizes, wherein the trading cost is based on a difference between a purchase price for the first currency and a sale price for the first currency, and wherein the generating is based on the price quotes from each of the venues in the set of electronic trading venues;
c) generating, at the one or more processors, a second cost curve that relates trading cost to order size for a plurality of order sizes, wherein the trading cost is based on a difference between purchase price for the first currency and sale price for the first currency, and wherein the generating is based on price quotes corresponding to a subset of the set of electronic trading venues;
d) receiving, at the one or more processors, an electronic trade order to trade the first currency for the second currency, the order received from the network communication interface;
e) determining, at the one or more processors, a first trading cost for the electronic trade order based on the first cost curve;
f) determining, at the one or more processors, a second trading cost for the electronic trade order based on the second cost curve, wherein the second trading cost is higher than the first trading cost; and
g) transmitting, to the network communication interface, the first trading cost and the second trading cost, which may be then transmitted as signals representing the first trading cost and the second trading cost, by the network communication interface.

In some instances, the set of electronic trading venues includes all available electronic trading venues that trade the first currency for the second currency. In more specific situations, the set of electronic trading venues includes all available banks that trade the first currency for the second currency and all available electronic communication networks (ECNs) that trade the first currency for the second currency, and wherein the subset includes said all available ECNs and does not include said all available banks.

In an embodiment, the method further involves determining a volatility value that indicates a level of volatility in a purchase price or sale price of the first currency, and then adjusting at least one of the first cost curve and the second cost curve based on the determined volatility value. More specifically, the one or more processors may receive, at the one or more processors, electronic data describing one or more currency option contracts, where the determining the volatility value is based on the electronic data describing one or more currency option contracts.

One embodiment of the present disclosure involves a system for facilitating currency exchange. The system includes a network communication interface and one or more processors. The network communication interface is configured to receive signals representing orders and pricing information from communication devices, and the one or more processors are in communication with the network communication interface and are configured to:
a) receive, from the network communication interface, electronic data describing price quotes from a set of electronic trading venues that trade a first currency for a second currency;
b) generate a first cost curve that relates trading cost to order size for a plurality of order sizes, wherein the trading cost is based on a difference between a purchase price for the first currency and a sale price for the first currency, and wherein the generating is based on the price quotes from the set of electronic trading venues;
c) generate a second cost curve that relates trading cost to order size for a plurality of order sizes, wherein the trading cost is based on a difference between purchase price for the first currency and sale price for the first currency, and wherein the generating is based on price quotes corresponding to a subset of the set of electronic trading venues, the subset being smaller than the set of electronic trading venues;
d) receive, from the network communication interface, an electronic trade order to trade the first currency for the second currency;
e) determine a first trading cost for the order based on the first cost curve;
f) determine a second trading cost for the order based on the second cost curve, wherein the second trading cost is higher than the first trading cost;
g) transmit the first trading cost and the second trading cost to the network communication interface.

1. A computerized network communication method executed by one or more processors, comprising:
receiving, at a network communication interface, signals representing electronic data indicating price quotes from a set of electronic trading venues that trade a first currency for a second currency and that provide electronic quotes;
receiving, at the one or more processors, the electronic data from the network communication interface in communication with the one or more processors;
generating, at one or more processors, a first cost curve that relates trading cost to order size for a plurality of order sizes, wherein the trading cost is based on a difference between a purchase price for the first currency and a sale price for the first currency, and wherein the generating is based on the price quotes from each of the venues in the set of electronic trading venues;
generating, at the one or more processors, a second cost curve that relates trading cost to order size for a plurality of order sizes, wherein the trading cost is based on a difference between purchase price for the first currency and sale price for the first currency, and wherein the generating is based on price quotes corresponding to a subset of the set of electronic trading venues;
receiving, at the network communication interface, signals representing an electronic trade order to trade the first currency for the second currency, the order received from the network communication interface;
receiving, at the one or more processors, the electronic trade order to trade the first currency for the second currency, from the network communication interface;
determining, at the one or more processors, a first trading cost for the electronic trade order based on the first cost curve;
determining, at the one or more processors, a second trading cost for the electronic trade order based on the second cost curve, wherein the second trading cost is higher than the first trading cost;
transmitting, to the network communication interface, the first trading cost and the second trading cost; and
transmitting, by the network communication interface, signals representing the first trading cost and the second trading cost.

2. The computerized method of claim 1, wherein the set of electronic trading venues includes all available electronic trading venues that trade the first currency for the second currency.

3. The computerized method of claim 2, wherein the set of electronic trading venues includes all available banks that trade the first currency for the second currency and all available electronic communication networks (ECNs) that trade the first currency for the second currency, and wherein the subset includes said all available ECNs and does not include said all available banks.

4. The computerized method of claim 1, further comprising:
determining a volatility value that indicates a level of volatility in a purchase price or sale price of the first currency; and
adjusting at least one of the first cost curve and the second cost curve based on the determined volatility value.

5. The computerized method of claim 4, further comprising:
receiving, at the one or more processors, electronic data describing one or more currency option contracts, wherein the determining the volatility value is based on the electronic data describing one or more currency option contracts.

6. The computerized method of claim 1, further comprising:
generating, at one or more processors, a third cost curve by collecting data from individual dealers (non-ECNS) and plotting the average all of the results on a cost curve;
generating, at one or more processors, a fourth cost curve by collecting data from individual dealers (non-ECNS) and plotting a curve with the lowest costs among the dealers;
determining, at the one or more processors, a third trading cost for the electronic trade order based on the third cost curve;
determining, at the one or more processors, a fourth trading cost for the electronic trade order based on the fourth cost curve;
wherein said transmitting steps also includes transmitting the third and fourth trading costs.

7. A network communication system for facilitating currency exchange, the system comprising:
a network communication interface and one or more processors, wherein the network communication interface is configured to receive signals representing orders and pricing information from communication devices, and wherein the one or more processors are in communication with the network communication interface and are configured to:
receive, from the network communication interface, electronic data describing price quotes from a set of electronic trading venues that trade a first currency for a second currency;
generate a first cost curve that relates trading cost to order size for a plurality of order sizes, wherein the trading cost is based on a difference between a purchase price for the first currency and a sale price for the first currency, and wherein the generating is based on the price quotes from the set of electronic trading venues;
generate a second cost curve that relates trading cost to order size for a plurality of order sizes, wherein the trading cost is based on a difference between purchase price for the first currency and sale price for the first currency, and wherein the generating is based on price quotes corresponding to a subset of the set of electronic trading venues, the subset being smaller than the set of electronic trading venues;
receive, from the network communication interface, an electronic trade order to trade the first currency for the second currency;
determine a first trading cost for the order based on the first cost curve;
determine a second trading cost for the order based on the second cost curve, wherein the second trading cost is higher than the first trading cost;
transmit the first trading cost and the second trading cost to the network communication interface.

8. The system of claim 7, wherein the set of electronic trading venues includes all available electronic trading venues that trade the first currency for the second currency.

9. The system of claim 8, wherein the set of electronic trading venues includes all available banks that trade the first currency for the second currency and all available electronic communication networks (ECNs) that trade the first currency for the second currency, and wherein the subset includes said all available ECNs and does not include said all available banks.

10. The system of claim 7, wherein the one or more processors are further configured to:
determine a value that indicates a level of volatility in a purchase price or sale price of the first currency; and
adjust at least one of the first cost curve and the second cost curve based on the determined volatility value.

11. The system of claim 10, wherein the one or more processors are further configured to receive, at the one or more processors, electronic data describing one or more currency option contracts, and
wherein the one or more processors are configured to determine the volatility value based on the electronic data describing one or more currency option contracts.

12. The system of claim 7, wherein the one or more processors are further configured to:
generate a third cost curve by collecting data from individual dealers (non-ECNS) and plotting the average all of the results on a cost curve;
generate a fourth cost curve by collecting data from individual dealers (non-ECNS) and plotting a curve with the lowest costs among the dealers;
determine a third trading cost for the electronic trade order based on the third cost curve;
determine a fourth trading cost for the electronic trade order based on the fourth cost curve; and
transmit the third and fourth trading costs.
